(19) United States
(12) Patent Application Publication
(10) Pub. No.: US 2005/0034065 A1
(43) Pub. Date: Feb. 10, 2005

(54) Method and apparatus for processing content

(75) Inventor: Christopher F. Weight, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/944,143

(22) Filed: Sep. 17, 2004

Related U.S. Application Data
(63) Continuation of application No. 09/848,705, filed on May 2, 2001.

(51) Int. Cl. G06F 17/00

(52) U.S. Cl. 715/513

(57) ABSTRACT

A system retrieves content from multiple content providers to be displayed on a Web page. The system verifies the format of the retrieved content and rejects the retrieved content when the content format is not valid. When the content format is valid, the retrieved content is stored in a central database. The content is then extracted from the central database to generate a schedule indicating particular content to be displayed at a specific date and time. The Web server displays the appropriate content at the specified date and time.

### RELATED APPLICATIONS

This application is a continuation of U.S. patent application Ser. No. 09/848,705, filed on May 2, 2001, entitled “Method and Apparatus for Processing Content”, naming Christopher F. Weight as inventor, the disclosure of which is hereby incorporated herein by reference.

### TECHNICAL FIELD

The present invention relates to computing systems and, more particularly, to an automated system for submitting, scheduling, and displaying content, such as Web-based content.

### BACKGROUND

Many Web sites contain content that is obtained from different content providers and updated at regular intervals. These Web sites may contain multiple Web pages that display various pieces of content, such as text and graphics. In certain situations, many pieces of content are updated regularly (e.g., hourly) and multiple Web pages are provided to support multiple different languages. Each of these multiple Web pages are also updated each time the content is updated.

For example, a particular Web page may display recent news headlines that are updated hourly, movie reviews that are updated daily, sports highlights that are updated hourly, sports scores that are updated every few minutes for games that are in progress, and a weather forecast that is updated as weather conditions change. In many situations, different pieces of content (and associated updates) are retrieved from different content providers. A particular Web server may be required to maintain and update multiple Web pages of the type described above.

This combination of multiple Web pages, multiple pieces of content on each page, regular updates, and multiple language support results in a large volume of Web page content that must be processed on a regular basis. Processing of this content includes obtaining the content from multiple content providers, formatting the content for the appropriate Web page, and handling content provided in multiple different languages.

Certain Web sites update different pieces of content at different times. Thus, content processing also includes determining when a particular piece of content is to be displayed on a particular Web page (e.g., the date and time the content is to be displayed on the Web page and, in some situations, the date and time the content is to be removed from the Web page). The content processing required for small amounts of content or for content that is updated infrequently may be handled manually by one or more administrators or other operators of the Web server maintaining the Web pages. This manual processing of Web page content is tedious and may require continual processing to ensure that all content updates are processed and displayed on the appropriate Web pages at the appropriate time. As the volume of the Web page content to be processed increases and/or the content requires frequent updating, attempting to process the content manually becomes increasingly difficult and may require a considerable amount of time by multiple administrators or other operators. At some point, this type of manual processing is no longer practical.

The systems and methods described herein address these limitations by providing an automated system for submitting, scheduling, and displaying content.

### SUMMARY

The system and method described herein automates a significant portion of the content processing associated with Web page data, thereby reducing the time required by an administrator or other operator of the Web server. An automated system retrieves content from multiple sources (also referred to as content providers), schedules various content for display at different dates and times on one or more Web pages, and displays the appropriate content on one or more Web pages at the scheduled time. The retrieved content is stored in a central database. Content is then extracted from the central database by a scheduling application that schedules content for display using one or more Web servers.

In one embodiment, content is retrieved from multiple content providers. The retrieved content is to be displayed in at least one Web page. The format of the retrieved content is then verified. When the format of the retrieved content is not valid, the content is rejected. Otherwise, the retrieved content is scheduled to be displayed at a specified time. The retrieved content is displayed by at least one server at the specified time.

In a described embodiment, the retrieved content is displayed using a test Web page. When the content is successfully displayed using the test Web page, then the content is displayed using a live Web page.

In another embodiment, the content is defined in an extensible markup language (XML) file.

A particular embodiment verifies the format of the retrieved content using a verification tool to compare the format of the retrieved content to the format defined in a schema file stored on the Web server.

In a particular embodiment, multiple content providers are identified by a system. The system then determines whether each of the multiple content providers has any new content to retrieve. The system retrieves new content from the multiple content providers that have new content to retrieve. The retrieved content is stored in a central database and scheduled to be displayed on a Web page at a particular time. The particular time is based on an attribute associated with the retrieved content. The retrieved content is then displayed on the Web page at the particular time.

### BRIEF DESCRIPTION OF THE DRAWINGS

FIG. 1 illustrates a block diagram of an environment in which content is collected from multiple content providers and displayed by a Web server.

FIG. 2 illustrates a block diagram of the content server shown in FIG. 1.

FIG. 3 is a flow diagram illustrating a procedure for processing content from multiple content providers.

FIG. 4 is a flow diagram illustrating a procedure for submitting content to be displayed by a Web server.

FIG. 5 is a flow diagram illustrating a procedure for retrieving content from multiple content providers.

FIG. 6 is a flow diagram illustrating a procedure for scheduling and displaying content in a Web page.

FIG. 7 illustrates an example of a suitable operating environment in which the content processing system and method may be implemented.

### DETAILED DESCRIPTION

The systems and methods described herein provide for the automated processing of content retrieved from multiple content providers. In particular, the system automates the submission of content from the content providers by utilizing a content collector that regularly retrieves content from each of the content providers. The system also automates the storage of the collected content as well as the scheduling of the display of collected content by a Web server. The automated system reduces the time spent by an administrator or other operator of the Web server. The automated system is capable of retrieving significant amounts of content from multiple content providers and retrieving updated content at regular intervals.

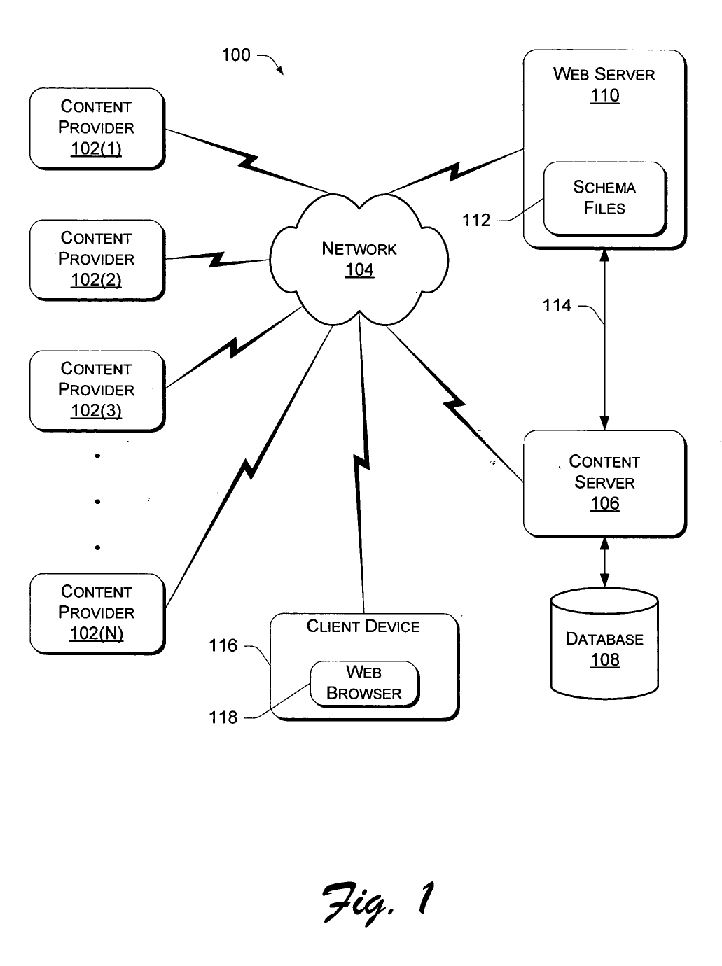

FIG. 1 illustrates a block diagram of an environment 100 in which content is collected from multiple content providers and displayed by a Web server. Multiple content providers 102(1)-102(N) generate various types of content for display by one or more Web servers (e.g., as part of a Web page maintained by a Web server). Any type of content can be generated by the content providers 102, including graphical content (e.g., pictures and graphs), textual content (e.g., news articles, movie reviews, and sports scores), audio content (e.g., music samples and sound effects), structured data, documents, links to other content (e.g., uniform resource locators (URLs) that point to other Web pages), or any other content that can be displayed on or accessed by a Web server. A particular Web page may contain any number of different content pieces of any content type. Content providers 102 may be located in a single geographic area or may be located throughout the world.

The multiple content providers 102 are coupled to a network 104, such as the Internet. Network 104 may be any type of network (or a combination of networks) having any network topology and using any network communication protocol. A content server 106 is also coupled to network 104, thereby allowing the content server to communicate with any of the content providers 102. Content server 106 performs various content processing functions, as discussed in greater detail below. Content server 106 is coupled to a database 108, which stores content data collected from the multiple content providers 102 as well as other data generated or used by the content server. In one implementation, database 108 is a Structured Query Language (SQL) database.

A Web server 110 is coupled to network 104 and content server 106. Thus, content server 106 can communicate with Web server 110 directly via communication link 114 or via network 104. Web server 110 typically maintains one or more Web pages that are distributed to one or more client devices 116 operating a Web browser application 118 to display the Web pages on the client device. For example, client device 116 may be a personal computer executing the Microsoft Internet Explorer Web browsing application available from Microsoft Corporation of Redmond, Wash. Alternatively, client device 116 can be a laptop computer, a handheld computer, a cellular phone, a personal digital assistant (PDA), or any other device capable of receiving and displaying at least one type of Web page content.

Web server 110 also includes a set of schema files 112 that are accessible by the content providers 102. The content providers 102 can use a content verification tool to verify that the content they are submitting to content server 106 is in the proper format such that the content will be accepted by the content server. To perform this verification, the content providers' content verification tool retrieves schema files 112 and compares the structure of the providers' content to the structure defined in the schema files. Schema files 112 may also be referred to as content structure definitions. When the content is not verified by the content verification tool, the content providers 102 can modify the content until it is verified by the content verification tool, thereby avoiding rejection of the content by content server 106. This configuration allows new content types to be created and defined by creating a new set of schema files, but without requiring any changes to the content verification tool.

Content server 106 and Web server 110 are illustrated in FIG. 1 as separate devices. However, in an alternate embodiment, content server 106 and Web server 110 are contained in a single device.

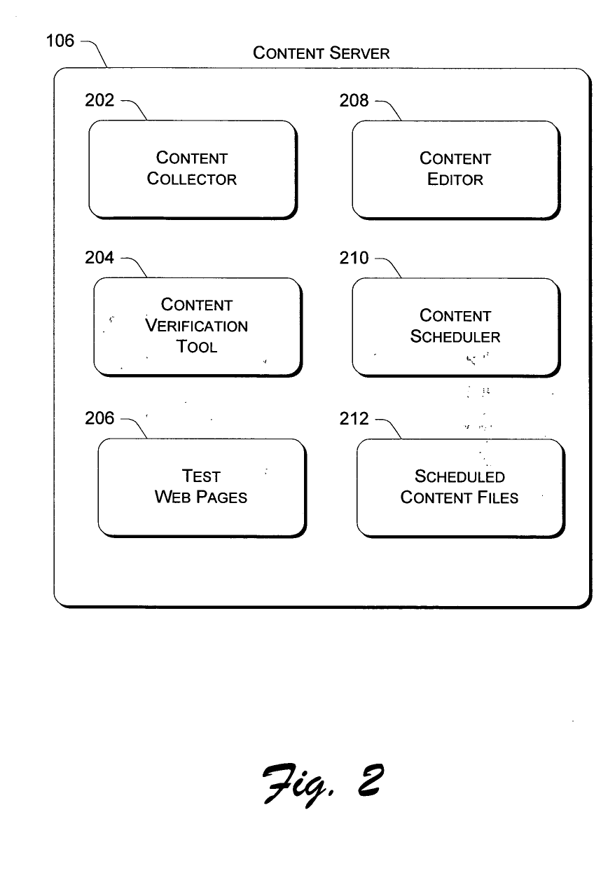

FIG. 2 illustrates a block diagram of the content server 106 shown in FIG. 1. Content server 106 includes a content collector 202 that collects various content from multiple content providers at regular intervals. Content server 106 also includes a content verification tool 204, which is used to verify that collected content is in an approved format before copying the collected content to the database. Content verification tool 204 is similar to the content verification tool used by the content providers. The collected content is verified using the content verification tool to compare the structure of the collected content to the structure defined in the schema files (i.e., schema files 112 in FIG. 1). Content server 106 also includes one or more test Web pages 206. These test Web pages 206 are generated prior to copying the Web page content to a “live” Web server, and allow an administrator or other operator to inspect the Web pages prior to displaying the Web page publicly.

Content server 106 also includes a content editor 208, which permits the editing of individual pieces of content as well as the editing of entire Web pages. A content scheduler 210 is used to schedule the display of various Web page content. Finally, content server 106 includes a set of scheduled content files 212. Scheduled content files 212 are schedule listings of, for example, content to be displayed on a particular date during a particular time period (e.g., May 1 from 1:00-9:00 p.m.). Additional details regarding the various modules in content server 106 are provided below.

Content server 106 is illustrated in FIG. 2 as a single device. However, in an alternate embodiment, content server 106 may be more than one device; i.e., the various modules of content server 106 may be located on any number of different computing devices.

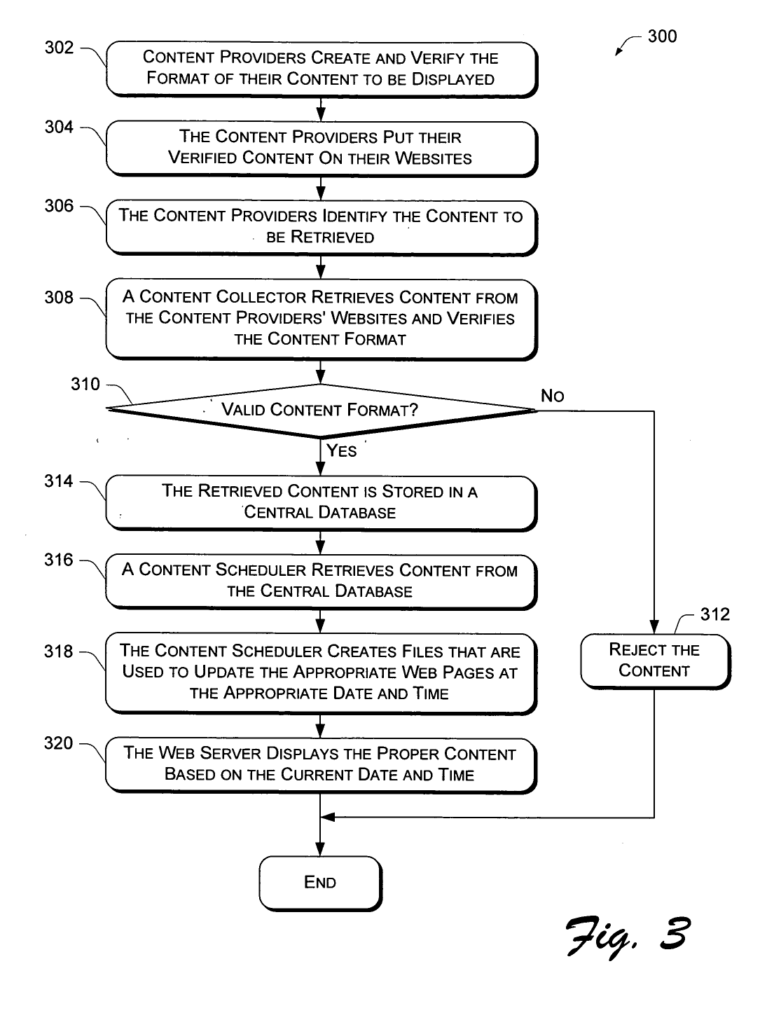

FIG. 3 is a flow diagram illustrating a procedure 300 for processing content from multiple content providers. Initially, one or more content providers create content to be displayed (e.g., included in a Web page) and verify the format of that content (block 302). As discussed above, the content may include, for example, graphical content, textual content, audio content, and/or links to other Web pages. To verify the content, the content providers can access the schema files 112 from Web server 110 and use a content verification tool to verify the providers' content. Use of the content verification tool with the schema files ensures that the format of the content meets the requirements of content server 106. In one implementation, the content verification tool used by the content providers performs the same verification process as the content verification tool 204 in content server 106. Additionally, both content verification tools access the same schema files. Thus, when the content is successfully verified by the content provider, the same content will be verified by content server 106. This verification provides a strong level of confidence for a content provider that the content will not be rejected by content server 106 due to an error in the format of the content.

At block 304 of FIG. 3, content providers put their verified content on their Web sites. The content providers then identify the content to be retrieved by the content server for displaying by Web servers (block 306). Next, a content collector in the content server retrieves content from the content providers' Web sites and verifies the content format (block 308). As discussed above, the content is verified using content verification tool 204 (FIG. 2) in content server 106.

When the content format is not valid, procedure 300 branches to block 312, which rejects the content. When the content format is valid, procedure 300 continues by storing the retrieved content in a central database, such as database 108 (block 314). A content scheduler retrieves content from the central database at block 316. Next, the content scheduler creates files that are used to update the appropriate Web pages at the appropriate date and time (block 318). The Web server then displays the proper content based on the current date and time (block 320).

This procedure 300 can be performed in an automated manner such that content is retrieved from content providers, verified, stored in a central database, scheduled, and displayed automatically, with little or no intervention by an administrator or other operator. Procedure 300 can be performed automatically regardless of the number of content providers, the amount of content retrieved, or the frequency with which content is updated.

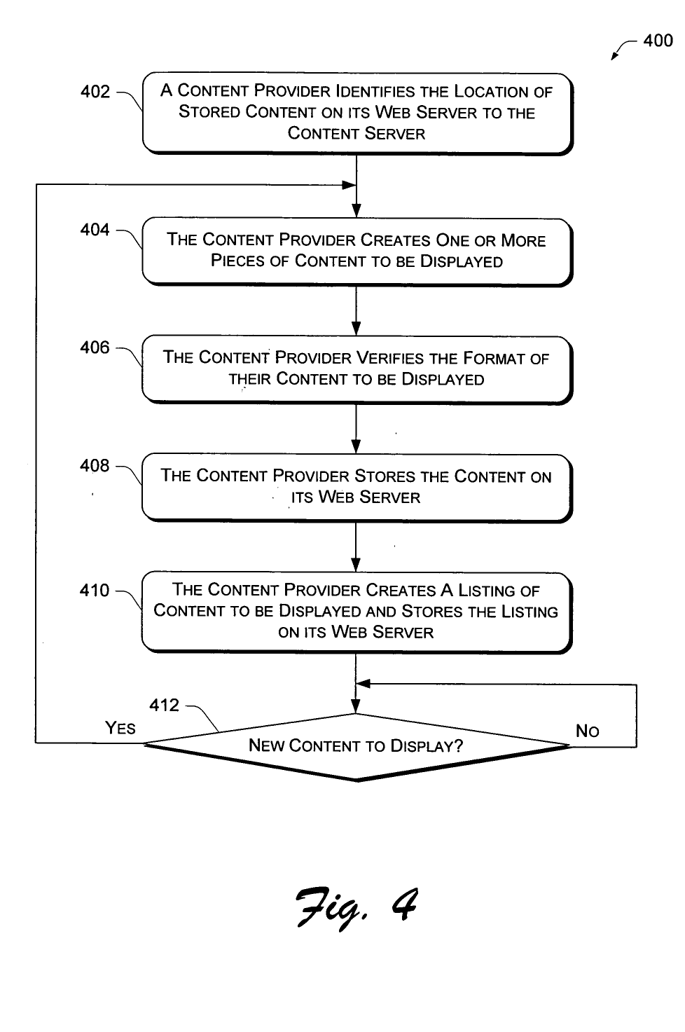

FIG. 3, discussed above, provides a general discussion of the procedure for retrieving, scheduling, and displaying content. FIG. 4 is a flow diagram illustrating, in greater detail, a procedure 400 for submitting content to be displayed by a Web server. Initially, a content provider identifies to the content server (e.g., content server 106) the location of stored content on its Web server (block 402). This stored content is supplied by the content provider for display on one or more Web pages. Each content provider may identify a different location on its own Web server where the content is stored. For example, one content provider may store its content in location: http:\\acompany.com\content and another content provider may store its content in location: http:\\bcorp.com\newcontent. The content server maintains this content storage location for each content provider. Additionally, the content provider identifies the name of the file that contains information about content to be retrieved. For example, a particular content provider may use a file named “filelist.txt”. This file identifies a media definition file (MDF), discussed below, that defines the content to be displayed. The file (e.g., “filelist.txt”) also identifies any image files associated with the content to be displayed. In a particular implementation, all content providers are required to use a file named “filelist.txt”.

At block 404 of FIG. 4, the content provider creates one or more pieces of content to be displayed in a Web page. The content provider then verifies the format of the content to be displayed using, for example, a content verification tool that accesses schema files 112 (block 406). When the content is verified successfully, the content provider stores the content on its Web server (block 408). At block 410, the content provider creates (or updates) a listing (e.g., filelist.txt) of content to be displayed and stores the listing at the appropriate location on its Web server (i.e., the location identified in block 402). When additional content is to be displayed, the procedure 400 returns to block 404. Otherwise, the procedure waits until additional content needs to be displayed.

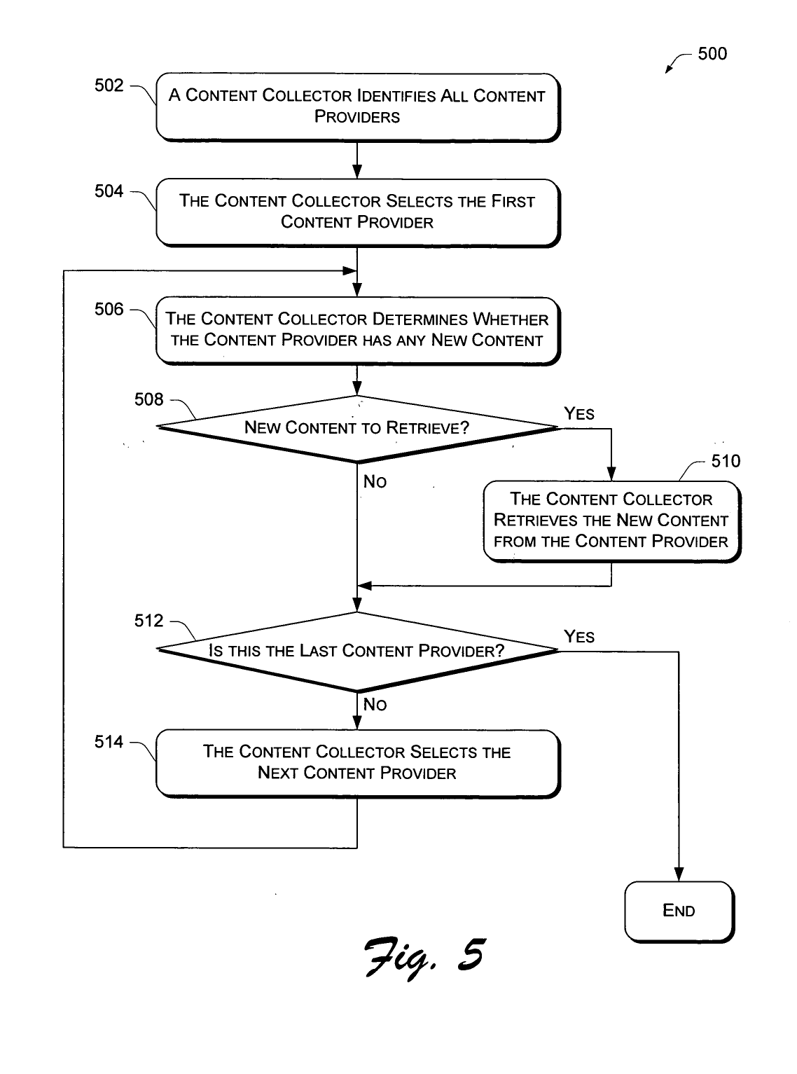

FIG. 5 is a flow diagram illustrating a procedure 500 for retrieving content from multiple content providers. This procedure may be performed at regular intervals, such as once every one or two hours, or at irregular intervals, such as 8:00 a.m., 12:00 p.m., 3:00 p.m., and 6:30 p.m. Initially, a content collector (e.g., content collector 202) identifies all content providers (block 502). In one implementation, the content providers initially make themselves known to the content collector. At block 504, the content collector selects the first content provider. The content collector then determines whether the content provider has 11 any new content to retrieve (block 506). This determination can be made by retrieving data, if any, from the file (e.g., filelist.txt) stored on the content provider's Web site.

In one embodiment, the content collector maintains a table of content providers and their associated files and a location for identifying new content. An example table, Table 1, is illustrated below.

TABLE 1

| Content Provider | Location | File Name |
|---|---|---|
| Company A | http:\\acompany.com\content | filelist.txt |
| Corporation B | http:\\bcorp.com\newcontent | filelist.txt |
| Company C | http:\\companyc.com\content | filelist.txt |
| Company D | http:\\dcompany.com\d_content | filelist.txt |
| Group E | http:\\egroup.org\content | filelist.txt |

The first column of Table 1 identifies the content provider. The second column of Table 1 identifies the location (e.g., URL) at which the content provider stores information regarding its content to be displayed. The third column of Table 1 identifies the name of the file that contains a listing of the content to be displayed (i.e., retrieved by the content collector).

When the content provider has new content to retrieve, the content collector retrieves the new content from the content provider (block 510). Otherwise, the procedure continues to block 512, which determines whether the current content provider is the last content provider to check for new content. When this was the last content provider, then the procedure 500 terminates. When additional content providers need to be checked for new content, the content collector selects the next content provider (block 514) and returns to block 506 to determine whether the next content provider has any new content. This process (blocks 506-514) is repeated until all content providers have been checked for new content, and all new content has been retrieved by the content collector. The content collector can retrieve any number of new content data files from any number of content providers.

As discussed above with respect to FIG. 3, all retrieved content is verified using content verification tool 204 in content server 106 and the verified content is stored in the central database (i.e., database 108).

As mentioned above, a media definition file (MDF) defines each piece of content to be displayed. The MDF file is an Extensible Markup Language (XML) file. XML is a meta-markup language that provides a format for describing structured data (e.g., Web content). XML provides a method for putting structured data into a text file. Before using XML for a particular type of structured data, a schema must first be defined. This schema defines the particular elements that are appropriate for the particular data. The specific structure of an MDF file (e.g., the name of the data elements and the ordering of those named data elements) is defined by a set of MDF schema files. Those MDF schema files (e.g., schema files 112 in FIG. 1) are themselves XML files that define the structure of the MDF file.

When a particular piece of content includes one or more images, the MDF file for that piece of content includes-a pointer to the image data. Typically, MDF files are computer-generated by the content provider. However, MDF files may also be generated manually by an administrator or other individual.

In a particular embodiment, the MDF file contains:
The actual content—text, images, etc.
Scheduling information—start and end date and time, status, priority, country, etc.
Contact information—where did this content come from and who do you contact if something is wrong.
   The MDF files received from content providers must include all of the required elements and those elements must be in the appropriate format. The format of MDF files is defined by the MDF Schema files. These schema files are generally made available to all content providers to allow the content providers to verify their MDF files against them. For example, in FIG. 1, the schema files 112 are made available to all content providers 102 via Internet access to Web server 110.

MDF files are comprised of a number of nested modules:

MDF (bookkeeping information such as created date, created by alias, modified date, modified by alias, etc.)

```
Content (scheduling information such as start datetime, end
datetime, status, priority, country, etc.)
    Feature (the text and images that make up the actual
    displayed content)
        Click(s) (URLs and alttext to define what happens
        when the user clicks on certain areas of the feature)
            Stream (certain clicks, such as Play, also
            specify the URL of a stream to be played)
Contact(s) (contact information)
```

Note that images are not stored in MDF files. The MDF file itself simply contains the path to an image file. The example above is for a Feature, which is a specific type of media content that is a primary visual component of one or more Web pages. The following is a specific example of an MDF:

```
<Feature xmlns=“x-schema:http:♯♯website.com♯Schemas♯
FeatureSchema.xml”>
  <Location>Music</Location>
  <Layout>Layout1</Layout>
  <HeadlineText>Jerry Sighted in Starbucks</HeadlineText>
  <EditorialText>It was him, I swear it. I tried to...</EditorialText>
  <AltText>Goin where the climate suits my clothes.</AltText>
  <LargeImagePath>Images♯LargeImage.GIF</LargeImagePath>
  <ClickList xmlns=
  “x-schema:http:♯♯website.com♯Schemas♯ClickListSchema.xml”>
    <Click ClickType=“Buy” LinkType=“Internal” Pay=“0”>
    <Text>New Dick's Pick</Text>
    <ClickURL>http:♯♯www.website.com♯buy. asp?id=123</ClickURL>
  </Click>
  <Click ClickType=“Play” LinkType=“External” Pay=“1”>
    <Text>DarkStar!</Text>
    <ClickURL>http:♯♯www.website.com♯Jerry</ClickURL>
    <Stream StreamType=“Normal”>
      <BitRate>100</BitRate>
      <StreamURL>http:♯♯www.website.com♯play.asp?id=12345&
      rate=100</StreamURL>
      </Stream>
    </Click>
  </ClickList>
</Feature>
```

As mentioned above, in one implementation, database 108 is a SQL database. In this implementation, the retrieved MDF files are stored in the SQL database. The SQL database is a relational version of the of the MDF hierarchy. The SQL database provides a direct mapping between the modules of an MDF file and the tables in the SQL database. Thus, it is possible to support new types of MDFs by defining the new type with appropriate XML-Schema file(s), adding new corresponding tables to the SQL database, and adding this new type to the list of types generated by the content scheduler (discussed below).

After the content collector has retrieved content from the content providers and stored the retrieved content in the database, a content scheduler (e.g., content scheduler 210 in FIG. 2) extracts content from the database and produces files, referred to as “scheduled content files”, that can be used by the Web server or other device that displays the content. Each piece of content has associated attributes, such as start date, start time, end date, end time, priority, status, and locale. These attributes may be set by the content provider and/or the administrator of the content server 106 or the Web server 110. These attributes are used by the content scheduler to generate one or more scheduled content files. The start date and start time identify the date and time at which the content should be displayed by the Web server. The end date and end time identify the date and time at which the content should be removed from the Web server (i.e., no longer displayed). The priority attribute may identify the priority of a particular piece of content relative to other pieces of content on the same Web page. The status attribute may indicate whether the content is ready to be displayed or whether the content is being tested and, therefore, not ready to be displayed. The locale attribute indicates the country or geographic region in which the content is to be displayed.

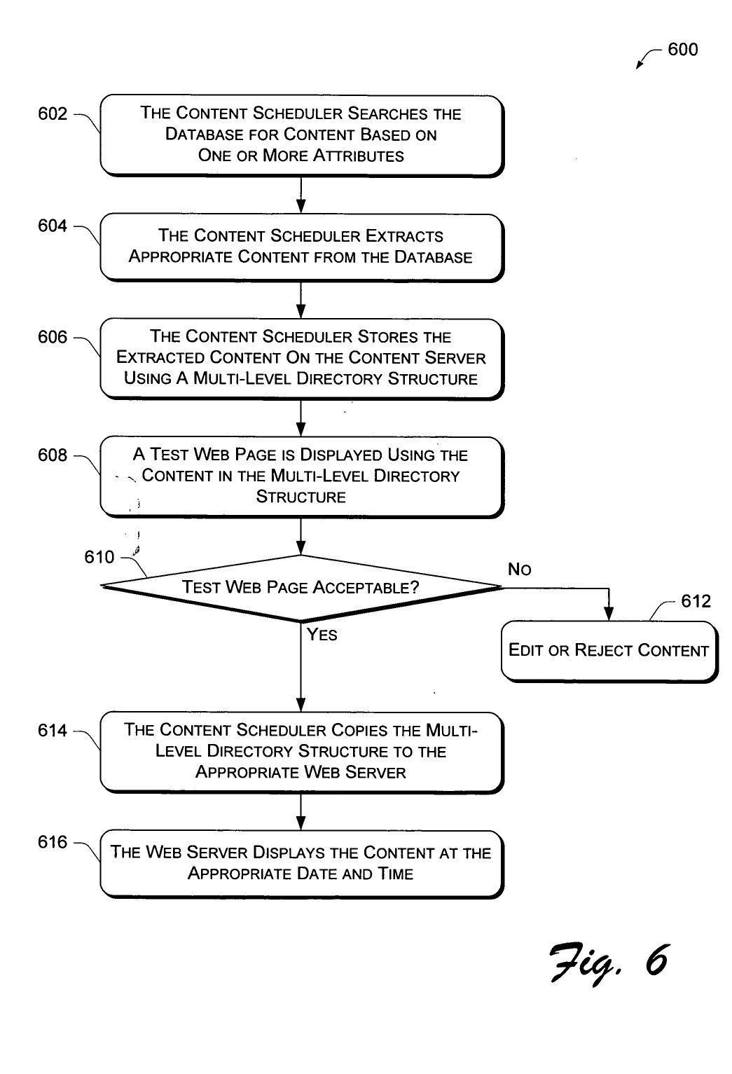

FIG. 6 is a flow diagram illustrating a procedure 600 for scheduling and displaying content in a Web page. The content scheduler searches the database for content based on one or more attributes (block 602). For example, the content scheduler may search for content that has a start date and start time within a particular time period (e.g., within the next 24 hours). The content scheduler extracts the appropriate content from the database (block 604). The content scheduler stores the extracted content on the content server using a multi-level directory structure (block 606). This multi-level directory structure includes multiple scheduled content files (e.g., scheduled content files 212 in FIG. 2).

After extracting appropriate data from the database, a test Web page is displayed using the content in the multi-level directory structure (block 608). The test Web page allows an administrator or other operator to review the Web page prior to displaying the Web page on the Web server.

When the test Web page is not acceptable, the procedure branches to block 612, where the content for the Web page is edited or rejected. The Web page or individual pieces of content can be edited using, for example, content editor 208 in content server 106. After editing the Web page and/or content, a new test Web page is displayed for review.

When the test Web page is acceptable, the content scheduler copies the multi-level directory structure (i.e., the scheduled content files) to the appropriate Web server (block 614). The appropriate Web server is the Web server that will maintain the Web page defined in the scheduled content files. The Web server then displays the content at the appropriate date and time (block 616).

A particular Web page is based on an HTML file, with the addition of JavaScript and/or image files. The scheduled content files (also referred to as a “schedule”) for a particular locale are a directory tree with directories corresponding to the dates and times for the covered time span and the JavaScript and image files that provide the actual schedule content.

In one embodiment, schedules are based around a timeslice, which is the smallest schedulable timeslot. In this embodiment, timeslices are four hours in length. The schedule directory tree below reflects the choice of a four hour timeslice; i.e., there is one directory for every timeslice in a schedule and that directory contains the JavaScript files for that timeslice. Images are placed higher in the directory tree than JavaScript files because they can be shared by many timeslices. The directory tree is represented as follows:

```
wwwroot - the Web site root directory
  schedule - contains all schedules
    en-us - the schedule for the United_States locale
      images files
      D2000-11-02 - one day's schedule
        T00-00 - one timeslice
          JavaScript files
        T04-00 - the next timeslice
          JavaScript files
        D2000-11-03 - the next day's schedule
          ...
    en-au - the schedule for the Australia locale
        ...
```

In the above example, all schedules are located under the “schedule” subdirectory. Further, all schedules for the United States are located in the same subdirectory “en-us”. For this subdirectory, “en” refers to the language (English) and “us” refers to the country (the United States). The subdirectory identified as “D2000-11-02” represents schedules for Nov. 2, 2000. The subdirectory identified as “T04-00” indicates that the particular timeslice begins at 4:00 a.m. If each timeslice is four hours in length, then timeslice “T04-00” runs from 4:00 a.m. to 8:00 a.m.

The Web page rendering application automatically looks in the appropriate directory given the locale set by the Internet site user and the current date and time. For example, if it is 4:30 a.m. on Nov. 2, 2000, the “T04-00” subdirectory illustrated above contains the information necessary for the Web 11 server to render an appropriate Web page for that date and time.

The content scheduler is able to generate schedules days or weeks into the future, depending on the information provided by the content providers. For example, to build a schedule of content for a particular week in the future, the content scheduler searches the database for content that has the appropriate date and time attributes. Schedules can be created automatically by executing the content scheduler at regular intervals. Alternatively, schedules can be created manually by, for example, an administrator.

To display a particular Web page on a client device, the Web server obtains the appropriate JavaScript and image files (if any) and sends those files to a browser application on the client device along with the static rendering code. Based on the locale of the client browser request, the current date, and the current time, the Web server identifies the appropriate directory and looks in that directory for certain JavaScript files. The JavaScript files define certain JavaScript objects that contain the content. When the rendering code and the JavaScript files and images (if any) are loaded into the client's browser application, the content is displayed in that Web page. Changing content does not require a change of the rendering code but instead the Web server locates and sends different JavaScript files, containing different content, and that different content is displayed by the browser application.

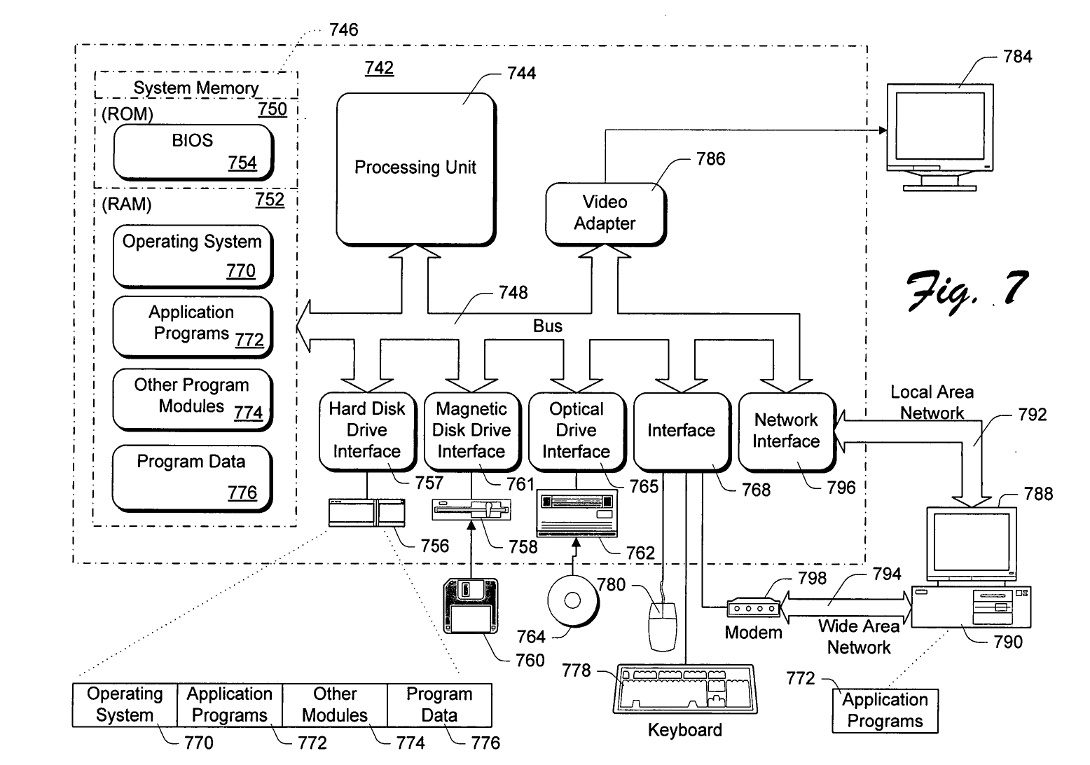

FIG. 7 illustrates an example of a suitable operating environment in which the content processing system described herein may be implemented. The illustrated operating environment is only one example of a suitable operating environment and is not intended to suggest any limitation as to the scope of use or functionality of the invention. Other well-known computing systems, environments, and/or configurations that may be suitable for use with the invention include, but are not limited to, personal computers, server computers, hand-held or laptop devices, multiprocessor systems, microprocessor-based systems, programmable consumer electronics, gaming consoles, cellular telephones, network PCs, minicomputers, mainframe computers, distributed computing environments that include any of the above systems or devices, and the like.

FIG. 7 shows a general example of a computer 742 that can be used in accordance with the invention. Computer 742 is shown as an example of a computer that can perform the various functions described herein. Computer 742 includes one or more processors or processing units 744, a system memory 746, and a bus 748 that couples various system components including the system memory 746 to processors 744.

The bus 748 represents one or more of any of several types of bus structures, including a memory bus or memory controller, a peripheral bus, an accelerated graphics port, and a processor or local bus using any of a variety of bus architectures. The system memory 746 includes read only memory (ROM) 750 and random access memory (RAM) 752. A basic input/output system (BIOS) 754, containing the basic routines that help to transfer information between elements within computer 742, such as during start-up, is stored in ROM 750. Computer 742 further includes a hard disk drive 756 for reading from and writing to a hard disk, not shown, connected to bus 748 via a hard disk drive interface 757 (e.g., a SCSI, ATA, or other type of interface); a magnetic disk drive 758 for reading from and writing to a removable magnetic disk 760, connected to bus 748 via a magnetic disk drive interface 761; and an optical disk drive 762 for reading from and/or writing to a removable optical disk 764 such as a CD ROM, DVD, or other optical media, connected to bus 748 via an optical drive interface 765. The drives and their associated computer-readable media provide nonvolatile storage of computer readable instructions, data structures, program modules and other data for computer 742. Although the exemplary environment described herein employs a hard disk, a removable magnetic disk 760 and a removable optical disk 764, it will be appreciated by those skilled in the art that other types of computer readable media which can store data that is accessible by a computer, such as magnetic cassettes, flash memory cards, random access memories (RAMs), read only memories (ROM), and the like, may also be used in the exemplary operating environment.

A number of program modules may be stored on the hard disk, magnetic disk 760, optical disk 764, ROM 750, or RAM 752, including an operating system 770, one or more application programs 772, other program modules 774, and program data 776. A user may enter commands and information into computer 742 through input devices such as keyboard 778 and pointing device 780. Other input devices (not shown) may include a microphone, joystick, game pad, satellite dish, scanner, or the like. These and other input devices are connected to the processing unit 744 through an interface 768 that is coupled to the system bus (e.g., a serial port interface, a parallel port interface, a universal serial bus (USB) interface, etc.). A monitor 784 or other type of display device is also connected to the system bus 748 via an interface, such as a video adapter 786. In addition to the monitor, personal computers typically include other peripheral output devices (not shown) such as speakers and printers.

Computer 742 operates in a networked environment using logical connections to one or more remote computers, such as a remote computer 788. The remote computer 788 may be another personal computer, a server, a router, a network PC, a peer device or other common network node, and typically includes many or all of the elements described above relative to computer 742, although only a memory storage device 790 has been illustrated in FIG. 7. The logical connections depicted in FIG. 7 include a local area network (LAN) 792 and a wide area network (WAN) 794. Such networking environments are commonplace in offices, enterprise-wide computer networks, intranets, and the Internet. In certain embodiments, computer 742 executes an Internet Web browser program (which may optionally be integrated into the operating system 770) such as the “Internet Explorer” Web browser manufactured and distributed by Microsoft Corporation of Redmond, Wash.

When used in a LAN networking environment, computer 742 is connected to the local network 792 through a network interface or adapter 796. When used in a WAN networking environment, computer 742 typically includes a modem 798 or other means for establishing communications over the wide area network 794, such as the Internet. The modem 798, which may be internal or external, is connected to the system bus 748 via a serial port interface 768. In a networked environment, program modules depicted relative to the personal computer 742, or portions thereof, may be stored in the remote memory storage device. It will be appreciated that the network connections shown are exemplary and other means of establishing a communications link between the computers may be used.

Computer 742 typically includes at least some form of computer readable media. Computer readable media can be any available media that can be accessed by computer 742. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computer 742. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as wired network or direct-wired connection, and wireless media such as acoustic, RF, infrared and other wireless media. Combinations of any of the above should also be included within the scope of computer readable media.

The invention has been described in part in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

For purposes of illustration, programs and other executable program components such as the operating system are illustrated herein as discrete blocks, although it is recognized that such programs and components reside at various times in different storage components of the computer, and are executed by the data processor(s) of the computer.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. One or more computer-readable memories containing a computer program that is executable by a processor to perform acts of:
retrieving content from a plurality of content providers, wherein the retrieved content is to be displayed in at least one Web page;
verifying the structure and format of the retrieved content;
rejecting particular content when the particular content format and structure is not valid; and
when the particular content format and structure are valid:
scheduling the particular content to be displayed at a specified time; and
displaying the particular content at the specified time, the particular content being displayed by a Web server.

2. The one or more computer-readable memories as recited in claim 1, wherein the computer program that is executable by a processor to perform acts of displaying particular content includes computer code contained therein that is executable by the processor to perform acts of:
displaying the particular content using a test Web page; and
when the particular content is successfully displayed using the test Web page, displaying the particular content using a live Web page.

3. The one or more computer-readable memories as recited in claim 1 wherein the computer program that is executable by a processor to perform acts of displaying particular content includes computer code contained therein that is executable by a processor to perform acts including deleting previously displayed content.

4. The one or more computer-readable memories as recited in claim 1 wherein the specified time is an attribute associated with the particular content.

5. The one or more computer-readable memories as recited in claim 1 further comprising computer code contained therein that is executable by a processor to perform acts including storing the retrieved data in a central database.

6. The one or more computer-readable memories as recited in claim 1 wherein the computer code contained therein that is executable by a processor to perform acts including scheduling the particular content includes computer code contained therein that is executable by a processor to perform acts including creating a multi-level directory structure associated with the specified time.

7. The one or more computer-readable memories as recited in claim 1 wherein the specified time is a timeslice having a start time and an end time.

8. The one or more computer-readable memories as recited in claim 1 wherein the content is defined in an extensible markup language (XML) file.

9. The one or more computer-readable memories as recited in claim 1 wherein the computer code contained therein that is executable by a processor to perform acts including verifying the format of the retrieved content includes computer code contained therein that is executable by a processor to perform acts including using a verification tool to compare the format of the retrieved content to the format defined in a schema file stored on the Web server.

10. The one or more computer-readable memories as recited in claim 1 wherein the computer code contained therein that is executable by a processor to perform acts including verifying the format of the retrieved content includes computer code contained therein that is executable by a processor to perform acts including using a verification tool to compare the format of the retrieved content to the format defined in a content definition file stored on the Web server.

11. One or more computer-readable memories containing a computer program that is executable by a processor to perform acts of:
identifying a plurality of content providers;
determining whether each of the plurality of content providers has any new content to retrieve;
retrieving new content from the plurality of content providers that have new content to retrieve;
storing the retrieved content in a central database;
scheduling the retrieved content to be displayed on a Web page at a particular time, wherein the particular time is based on an attribute associated with the retrieved content; and
displaying the retrieved content on the Web page at the particular time.

12. The one or more computer-readable memories as recited in claim 11 wherein the retrieved content is defined in an extensible markup language (XML) file.

13. The one or more computer-readable memories as recited in claim 11 further comprising computer code contained therein that is executable by a processor to perform acts including verifying the format of the retrieved content.

14. The one or more computer-readable memories as recited in claim 11 further comprising computer code contained therein that is executable by a processor to perform acts including:
verifying the format of the retrieved content; and
rejecting content that is not verified.

15. The one or more computer-readable memories as recited in claim 11 further comprising computer code contained therein that is executable by a processor to perform acts including:
verifying the structure of the retrieved content; and
editing the content structure when the retrieved content structure is not verified.

16. The one or more computer-readable memories as recited in claim 11 further comprising computer code contained therein that is executable by a processor to perform acts including:
verifying the structure of the retrieved content by comparing the structure to a schema file;
editing the content structure when the retrieved content structure is not verified.

17. The one or more computer-readable memories as recited in claim 11 further comprising computer code contained therein that is executable by a processor to perform acts including deleting previously displayed content after the particular time.

18. The one or more computer-readable memories as recited in claim 11 wherein the retrieved content has an associated time slice, the time slice identifying a start date, a start time, an end date, and an end time.

19. One or more computer-readable memories containing a computer program that is executable by a processor to perform acts of:
identifying a plurality of content providers;
identifying a storage location associated with each of the content providers;
retrieving a file from each storage location, wherein the file identifies any new content to retrieve from the storage location;
when the file identifies new content to retrieve from the storage location:
retrieving the new content;
storing the retrieved content in a central database; and
scheduling the retrieved content to be displayed at a particular time, wherein the particular time is based on an attribute associated with the retrieved content.

20. The one or more computer-readable memories as recited in claim 19 further comprising computer code contained therein that is executable by a processor to perform acts including displaying the retrieved content on the Web page at the particular time.

21. The one or more computer-readable memories as recited in claim 19 further comprising computer code contained therein that is executable by a processor to perform acts including verifying the format of the retrieved content and rejecting the retrieved content when the format is not valid.

22. The one or more computer-readable memories as recited in claim 19 further comprising computer code contained therein that is executable by a processor to perform acts including verifying the format of the retrieved content using a verification tool to compare the format of the retrieved content to the format defined in a schema file stored on a Web server.

23. A content server comprising:
a content collector configured to receive verified content from a plurality of content providers via a content verification tool coupled to the content collector; and
a content scheduler coupled to the content collector, the content scheduler configured to schedule the received verified content for display.

24. A content server as recited in claim 23 further including a content editor coupled to the content scheduler and configured to modify the received verified content.

25. A content server as recited in claim 23 further including a test Web page configured to display the received verified content.

26. A content server as recited in claim 23 wherein the content verification tool rejects content when the received verified content format is not valid.

27. A content server as recited in claim 23 further including a database configured to store the received verified content.

28. A content server as recited in claim 23 wherein the content is defined in an extensible markup language (XML) file.

29. A content server comprising a content collector configured to receive verified content from a plurality of content providers via a content verification tool coupled to the content collector, the content collector being configured to:
retrieve content from a plurality of content providers, wherein the retrieved content is to be displayed in at least one Web page; and
wherein the content verification tool is configured to:
verify the structure and format of the retrieved content by comparing the structure and content to a schema file that includes content structure definitions, wherein the schema file is configured to be editable.

30. A content server as recited in claim 29, further comprising a content scheduler coupled to the content collector, the content scheduler configured to schedule the received verified content for display, the content scheduler being configured to:
reject particular content when the particular content format and structure is not valid; and
when the particular content format and structure are valid:
schedule the particular content to be displayed at a specified time; and
display the particular content at the specified time, the particular content being displayed by a Web server.

31. A content server as recited in claim 29, wherein the content verification tool is coupled to a structured query language database, and wherein, when the content is verified, the content is stored in the structured query language database.

32. A content server as recited in claim 29, wherein the schema file comprises extensible markup language (XML) files, and wherein the schema file is configured to accept additional XML schema files corresponding to new content formats.
